(19) United States
(12) Patent Application Publication
(10) Pub. No.: US 2007/0195724 A1
(43) Pub. Date: Aug. 23, 2007

(54) Method and apparatus for transmitting broadcasting data with a plurality of information

(75) Inventors: Hye Jung Yang, Busan-si (KR); Hyun Suk Min, Suwon-si (KR); Jin Won Kim, Seoul (KR); Kwang Soo Kim, Seoul (KR); Sung Chul Yang, Suwon-si (KR); Suk In Jung, Seoul (KR); Jong Hyun Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/588,790

(22) Filed: Oct. 27, 2006

(30) Foreign Application Priority Data
Feb. 17, 2006 (KR) 2006-0015369

(51) Int. Cl. H04B 7/212

(52) U.S. Cl. 370/321; 370/442

(57) ABSTRACT

The present invention relates to an apparatus for broadcast data transmission and a method thereof A method for transmission of broadcast data includes a plurality of information that includes setting up a transmission period by information/time slot for each of the plurality of information; receiving information transmitted from outside information providing servers; storing the received information; generating broadcast data including the stored information based on the transmission period by information/time slot in every transmission period of broadcast data; and broadcasting the generated broadcast data.

This application claims priority under 35 U.S.C. §119 from Korean Patent Application No. 2006-0015369, which was filed in the Korean Intellectual Property Office on Feb. 17, 2006, the contents of which are incorporated by reference herein in its entirety.

### BACKGROUND OF THE INVENTION

1. Field of the Invention

The present invention relates to an apparatus for broadcast data transmission and method thereof, and in particular, to an apparatus for broadcast data transmission and method thereof, the broadcast data including a plurality of information, such as live information including traffic information, weather information and stock information, which change over the transmission period of the information by time and kind of information.

2. Description of the Related Art

Currently, provided in broadcast transmission is digital multimedia broadcast DMB service broadcasting various multimedia signals such as voice and image that is modulated into digital data. The DMB service may be provided through a car receiver or a personal mobile receiver equipped with nondirectional RX-antenna to receive a various multimedia broadcast while moving.

The memory loading technique for storing digital multimedia data having a high capacity such as a moving picture or a music video has been developed, and the mobile communication terminal has been widely distributed. The mobile communication terminal, for example, is a DMB phone that can receive DMB data has been widely commercialized. Therefore, users can watch a DMB broadcast by using the DMB while moving.

The DMB data format, in general, includes audio area, video area and data area. By using the data area, the DMB broadcast station provides users with various live information such as traffic information, weather information and stock information. For this, the DMB broadcast station receives various living information from the corresponding information service center to deliver while the information is included in the data area.

The DMB broadcast service providing server installed in the DMB broadcast station receives corresponding information from a plurality of information providing servers to perform broadcasting after generating DMB data including the information. The example of the transmission procedure of broadcast data is exemplified in FIG. 1.

FIG. 1 is a drawing showing an example of the general process of transmission of the broadcast data including a plurality of information.

FIG. 1 shows the example of the process where a broadcast service providing server 40 which receives a first, a second and a third information from a first, a second and a third information providing server 10, 20 and 30, provides the first, the second and the third information to a mobile communication terminal 50.

Referring to FIG. 1, the broadcast service providing server 40 receives the first information from the first information providing server 10 S11, receives the second information from the second information providing server 20 S13, receives the third information from the third information providing server 30 S15, and generates broadcast data including the received informations S17. At this time, the broadcast service providing server 40 generates broadcast data for all of the information in a constant cycle.

That is, after generating broadcast data including the first, the second and the third information, the broadcast service providing server 40 broadcasts the data to the mobile communication terminal 50 based on the transmission period determined by the broadcast station S19.

In this way, in a conventional type of terminal, all kinds of live information, for example, traffic information, weather information, and stock information included in broadcast data, are transmitted over time or with a constant period determined by the broadcast station without considering the weather conditions.

However, the demand for live information changes over time or by weather condition due to the characteristic of the information. For example, in an office-going hour, there is a more demand on traffic information rather than stock information. Further, when it snows or rains heavily or snow or rain is predicted, the demand on weather information will increase. However, in the conventional type, by transmitting all kinds of live information set up in advance in a constant transmission period without considering the change of such information demand at all, a convenient information providing was not able to be given to users.

Further, as to the offer of the living informations, the requirement of the user was not reflected. That is, conventionally, by transmitting all kinds of the live information set up in advance in a constant transmission period, the broadcast station could not cope with the change of the requirement of the user. Therefore, there is a problem in that users cannot use the live information conveniently.

### SUMMARY OF THE INVENTION

Accordingly, an aspect of the present invention is to solve at least the problems and disadvantages of the background art.

The present invention provides an apparatus for broadcast data transmission and method thereof, with broadcast data including a plurality of information such as live information including traffic information, weather information and stock information, which changes over the transmission period of the information over time and kind of information.

Further, the present invention provides an apparatus for broadcast data transmission and method thereof that includes a plurality of information having a different transmission period according to the requirement of a user.

A method for transmission of broadcast data including a plurality of information according to the present invention includes setting up a transmission period by information/time slot for each of the plurality of informations; receiving information transmitted from outside information providing servers; storing the received information; a broadcast data generating step of generating broadcast data including the stored information based on the transmission period by information/time slot in every transmission period of broadcast data; and broadcasting the generated broadcast data.

### BRIEF DESCRIPTION OF THE DRAWINGS

The invention will be described in detail with reference to the following drawings in which like numerals refer to like elements. The accompany drawings, which are included to provide a further understanding of the invention and are incorporated in and constitute a part of this specification, illustrate embodiments of the invention and together with the description serve to explain the principles of the invention. In the drawings:

FIG. 1 is a drawing showing an example of the general process of the transmission of broadcast data including a plurality of information;

FIG. 2 is a drawing showing an example of the process of the transmission of broadcast data including a plurality of information according to the present invention;

FIG. 3 is a block diagram showing a broadcast service providing server for performing the process exemplified in FIG. 2;

FIG. 4 shows an example of database for managing broadcast data transmission period according to kind of information and time in a broadcast service providing server exemplified in FIG. 3;

FIG. 5 is a flow chart showing a broadcast data transmission method according to the present invention;

FIG. 6A, FIG. 6B are drawings showing an example of broadcast data generated by using the transmission period information exemplified in FIG. 4;

FIG. 7 is a drawing showing an example of the process of transmission of broadcast data including a plurality of information according to the present invention;

FIG. 8 is a block diagram showing a broadcast service providing server for performing the process exemplified in FIG. 7;

FIGS. 9A to 9B and FIGS. 10A to 10B are drawings showing an example of the process among a mobile communication terminal, a mobile communication service providing server and a broadcast service providing server for performing the process exemplified in FIG. 7; and

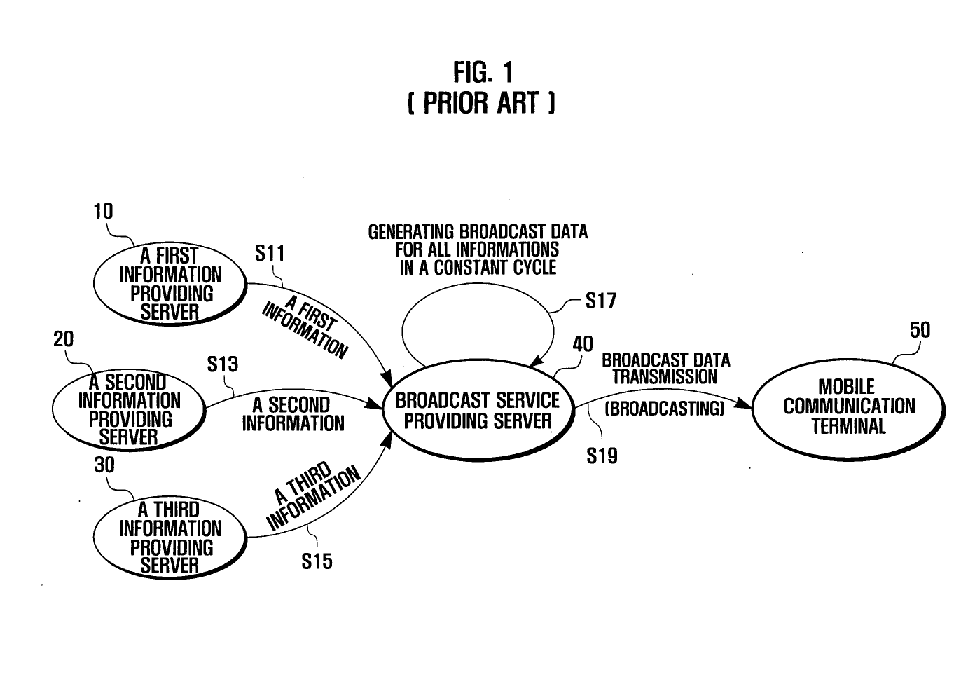

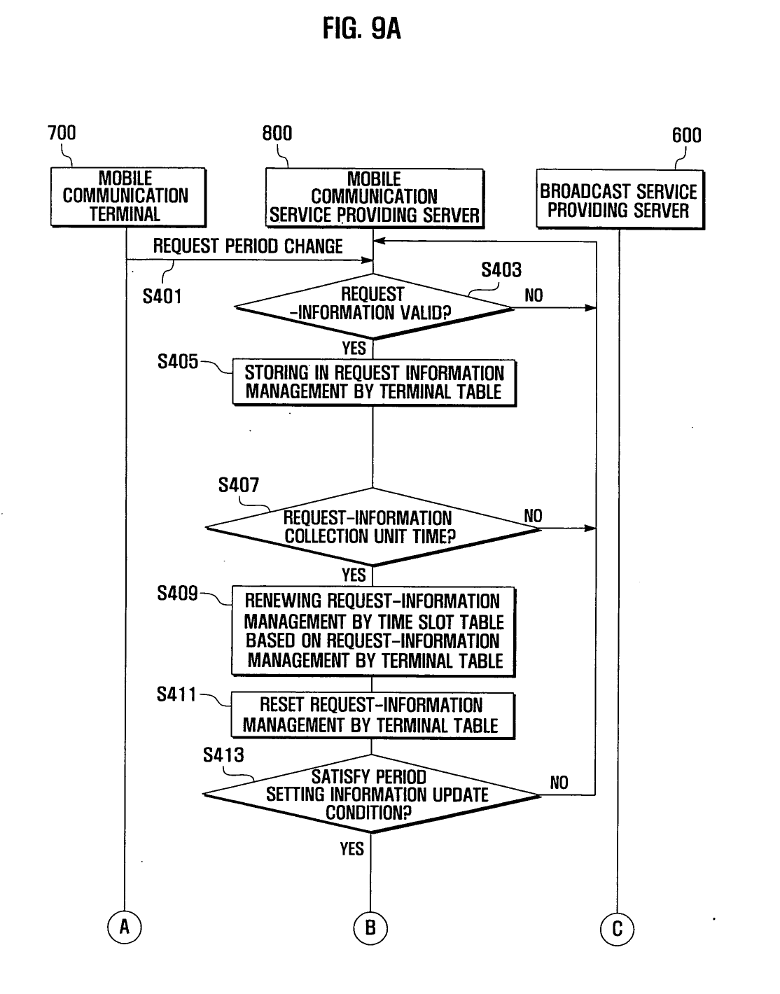

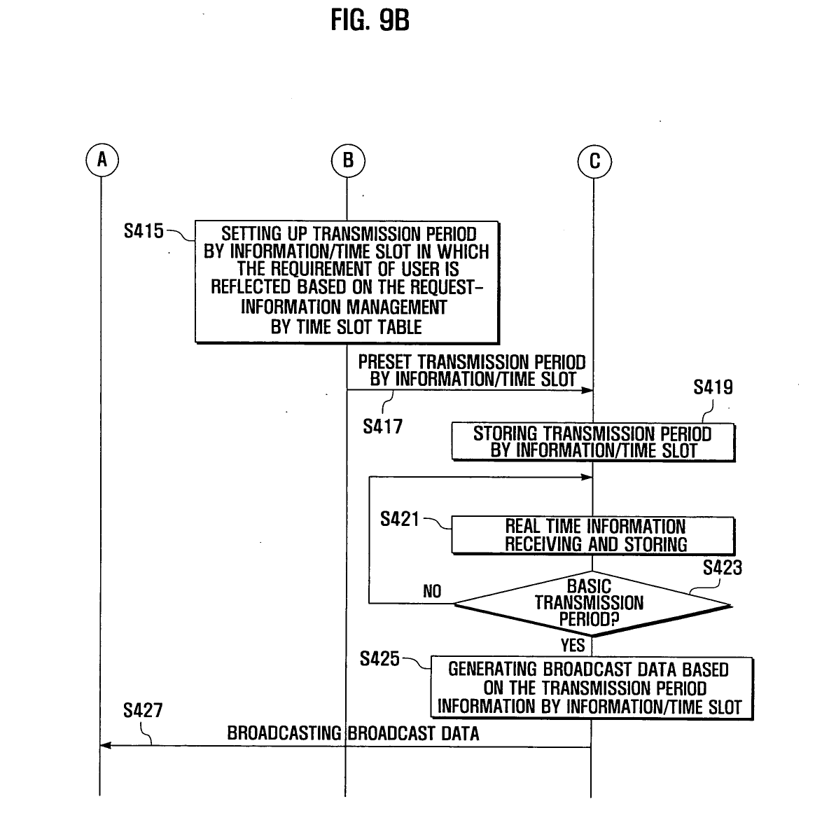

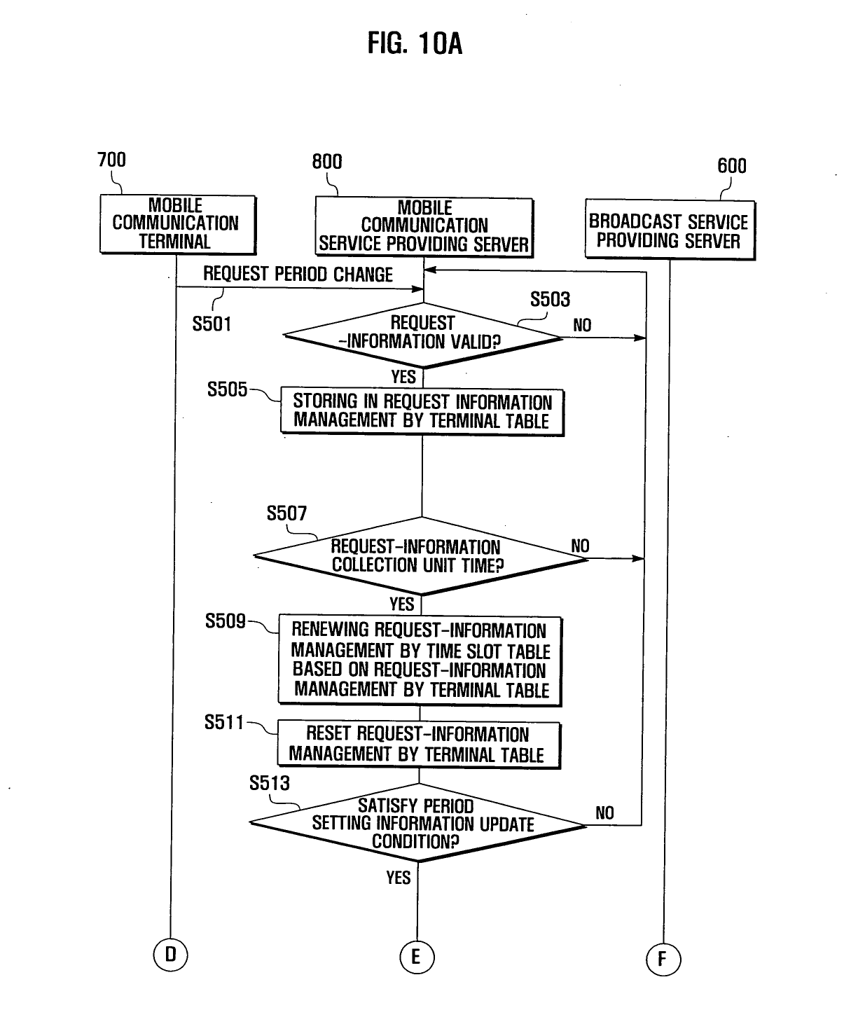

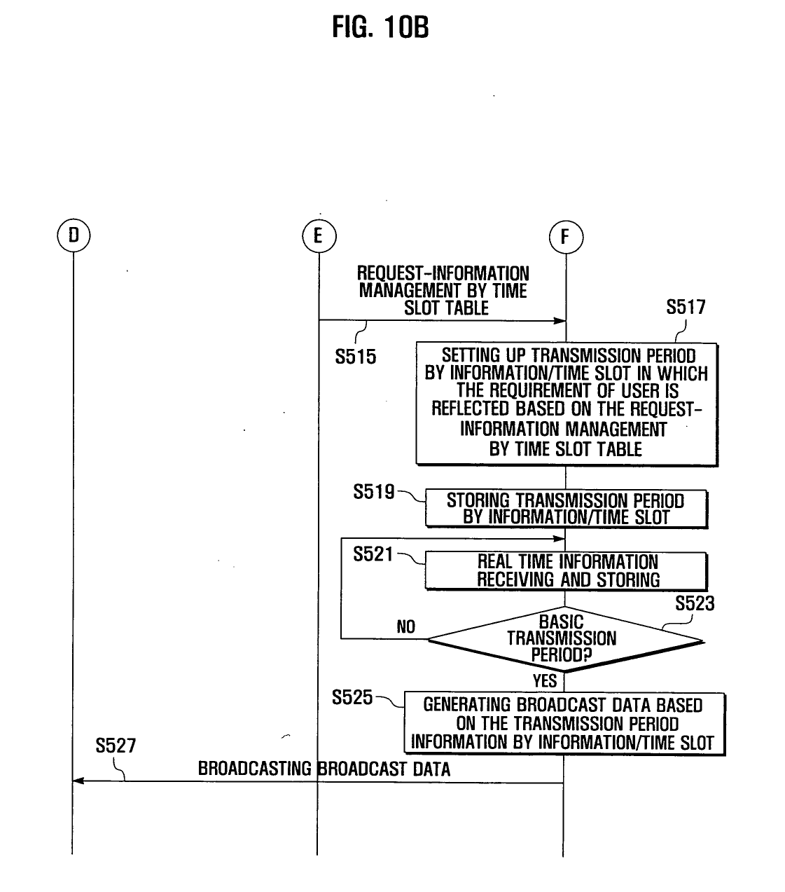

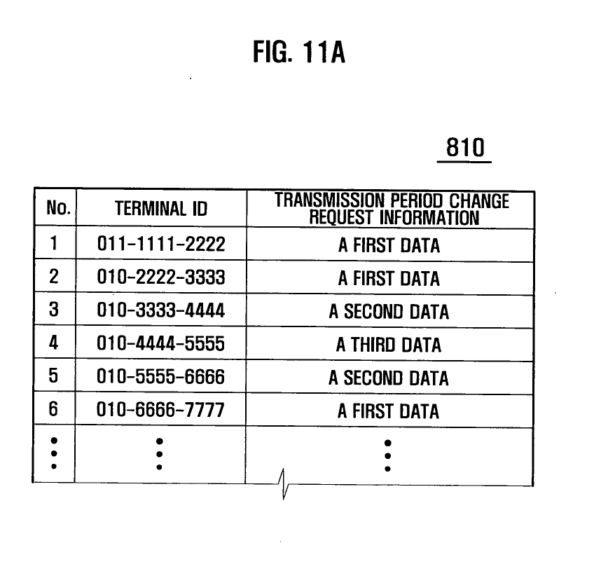

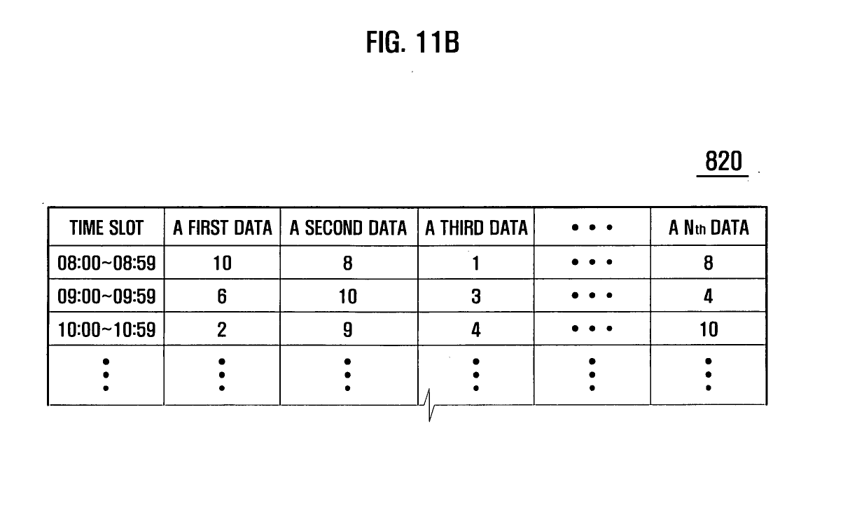

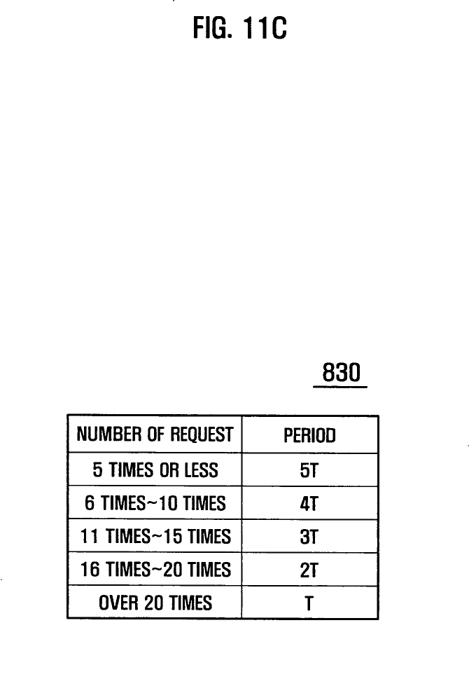

FIG. 1A to FIG. 11C are drawings showing an example of information management tables for managing information necessary for performing the process exemplified in FIG. 9A to 9B and FIG. 10A to 10B.

### DETAILED DESCRIPTION OF PREFERRED EMBODIMENTS

Preferred embodiments of the present invention will be described in a more detailed manner with reference to the drawings. Reference will now be made in detail to embodiments of the present invention, examples of which are illustrated in the accompanying drawings.

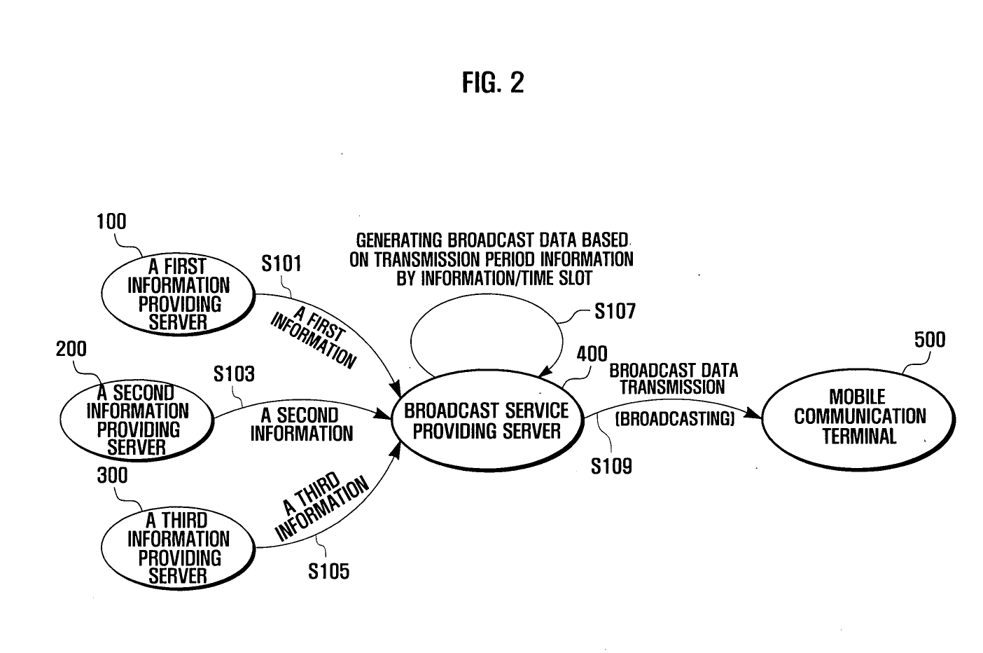

FIG. 2 is a drawing showing an example of the process of the transmission of broadcast data including a plurality of information according to a first embodiment of the present invention.

In FIG. 2, it is shown that the broadcast service providing server providing the broadcast service stores the transmission period of each information differently set up by kind of information and time, generating and transmitting broadcast data including the information based on the transmission period.

Referring to FIG. 2, the broadcast service providing server 400 receives the first information from the first information providing server 100 S101, receiving the second information from the second information providing server 200 S103, receiving the third information from the third information providing server 300 S105, and then, manages/stores the information.

The broadcast service providing server 400 generates broadcast data including the informations with the transmission period of broadcast data based on the transmission period information classified by the kind of the information and time slot stored in advance S107. At this time, it is preferable that the first to the third information are all kinds of live information such as traffic information, weather information, and stock information.

Further, in the process S107, the broadcast service providing server 400 generates broadcast data including information based on the stored transmission period for each of the first to the third information. For this, it is preferable that the broadcast service providing server 400 stores the transmission period information differently set up in accordance with the kind of the information and time slot for all information capable of being transmitted with broadcast data.

For example, it is preferable that the broadcast service providing server 400 sets the transmission period of the traffic information in the first place among places for traffic information, weather information and stock information, during the rush hour, sets the transmission period of the stock information first among traffic information, weather information and stock information during the stock trade times, sets the transmission period of the weather information first when snow or rain is predicted, and then, the set transmission period is stored by kind of the information and the time slot.

In this way, the broadcast service providing server 400 generating broadcast data based on the stored information of transmission period information classified by information/time slot broadcasts the data to mobile communication terminal 500 S109. At this time, the broadcast service providing server 400 transmits the generated broadcast data based on the transmission period set up in advance to the mobile communication terminal 500.

As described in the above, in the present invention, broadcast data is generated and transmitted based on the stored transmission period information classified by information and time slot. Therefore, it is preferable that the broadcast service providing server 400 sets up the transmission period information classified by information and time slot in consideration of the characteristic of each informations.

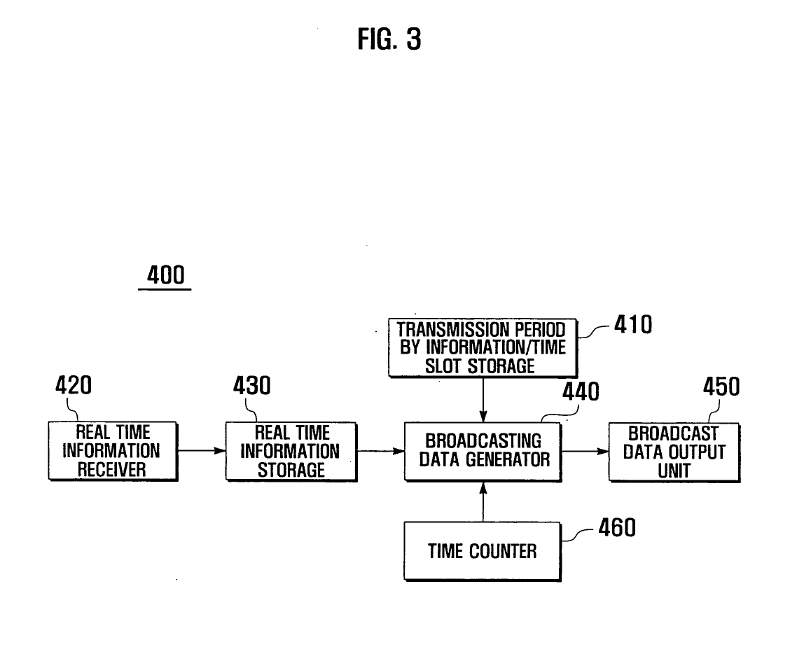

FIG. 3 is a block diagram showing a broadcast service providing server for performing the process exemplified in FIG. 2.

FIG. 3 shows a block of the broadcast service providing server 400 exemplified in FIG. 2.

Referring to FIG. 3, the broadcast service providing server 400 includes a transmission period by information/time slot storage 410, a real time information receiver 420, a real time information storage 430, a broadcasting data generator 440, a broadcast data output unit 450 and a time counter 460.

The transmission period by information/time slot storage 410 stores the transmission period information set up in advance for all the information that can be transmitted with the broadcast data. At this time, it is preferable that the transmission period information is differently set up by the kind of the information for each of the information.

Further, it is preferable that the demand is predicted by time slot according to the characteristic of each information and the transmission period information is set up based on the sequence.

The real time information receiver 420 receives information transmitted from the outside information providing server in real time. Particularly, the real time information receiver 420 receives corresponding information from various information providing servers providing live information including traffic information, weather information, and stock information. The received information is delivered to the real time information storage 430.

The real time information storage 430 receives and stores real time information delivered from the real time information receiver 420. The real time information storage 430 stores information with the identifying information.

The broadcasting data generator 440 generates broadcast data based on the broadcast data transmission period set up in advance. Particularly, the broadcasting data generator 440 generates broadcast data including information stored in the real time information storage 430 based on the transmission period information stored in the transmission period by information/time slot storage 410.

For this, the broadcasting data generator 440 receives broadcast data transmission period information from the time counter 460 and generates broadcast data at the broadcast data transmission.

The time counter 460 counts the time to deliver for the broadcasting data generator 440. Particularly, the time counter 460 stores the transmission period information of broadcast data and counts the time so as to deliver it to the broadcasting data generator 440 at the proper transmission period.

The broadcast data output unit 450 receives broadcast data generated in the broadcasting data generator 440 in the broadcast data transmission period to output the broadcast data. That is, the broadcast data is broadcasted.

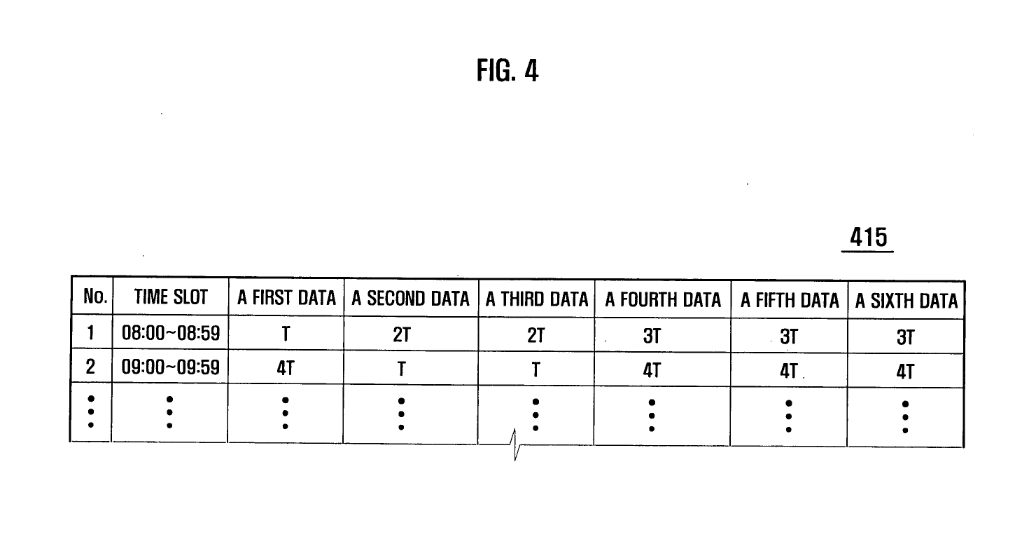

FIG. 4 shows an example of database for managing broadcast data transmission period according to kind of information and time slot in a broadcast service providing server exemplified in FIG. 3.

Particularly, FIG. 4 shows an example of a basic transmission period, for example, shows an example of the transmission period by time slot for a first data through a sixth data in case the broadcast data transmission period is ‘T’.

Referring to FIG. 4, in time slot 08:00˜08:59, the transmission period of the first data is T, while the transmission period of the second and the third data is 2 T, and the transmission period of the fourth to the sixth data is 3 T. In time slot 09:00˜09:59, the transmission period of the first, the fourth, the fifth and the sixth data is 4 T, while the transmission period of the second and third data is T.

Therefore, the first data is broadcasted with all broadcast data in case slot 08:00˜08:59. In time slot 09:00˜09:59, the first data is broadcasted with every fourth broadcast data. Furthermore, in time slot 08:00˜08:59, the second data is broadcasted with every second broadcast data, while the second data is broadcasted with all broadcast data in time slot 09:00·09:59.

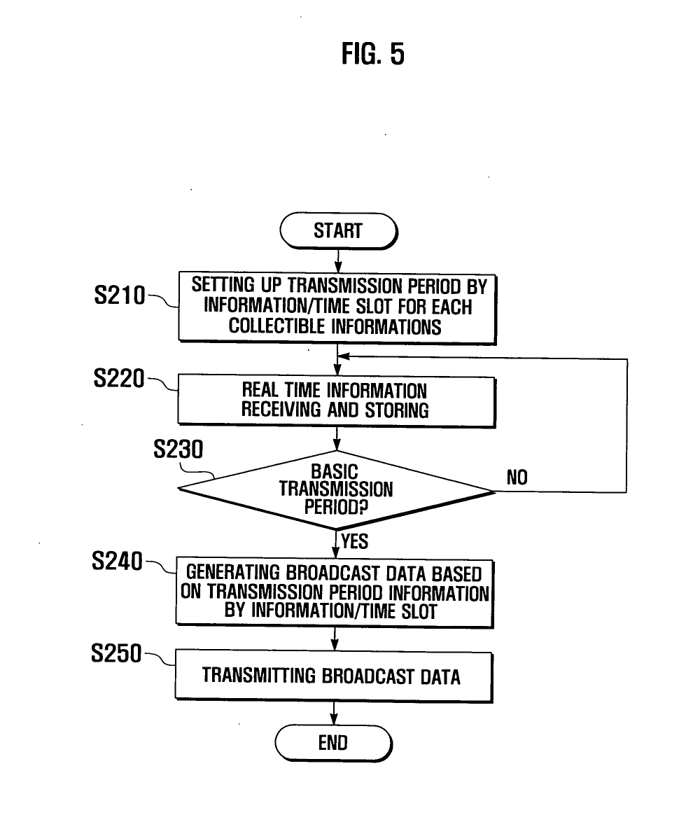

FIG. 5 is a flow chart showing a broadcast data transmission method according to the present invention. That is, FIG. 5 shows an example of the process of the broadcast service providing server 400 exemplified in FIG. 3.

Referring to FIG. 5, the broadcast service providing server 400 sets up the transmission period by information/time slot for each collectible information S210.

That is, the broadcast service providing server 400 sets up the transmission period by information/time slot for broadcasting each information which can be transmitted, while the information is included in the broadcast data.

It is preferable that the demand of each information by time slot is predicted according to the characteristic of each information, and then, the transmission period by information/time slot is set up based on the sequence.

The transmission period by information/time slot is stored in the transmission period by information/time slot storage 410. The storage example of the transmission period by information/time slot is identical with FIG. 4.

The broadcast service providing server 400 receives real time information through the real time information receiver 420 and stores the information in the real time information storage 430 S220. It is preferable that the received information is all kinds of live information that can include traffic information, weather information and stock information.

The broadcasting data generator 440 counts the time to confirm the basic transmission period, or the broadcast data transmission period S230, and generates broadcast data based on the transmission period information by information/time slot set up in the process S210 S240.

It is preferable that the broadcasting data generator 440 information determines information to be transmitted in transmission time among the real time information stored in the process S220 based on the transmission period by information/time slot, and generates broadcast data including the information which is determined to be transmitted in transmission time based on the result of the determination. The broadcasting data generator 440 generates the broadcast data and broadcasts the broadcast data through the broadcast data output 450 S250

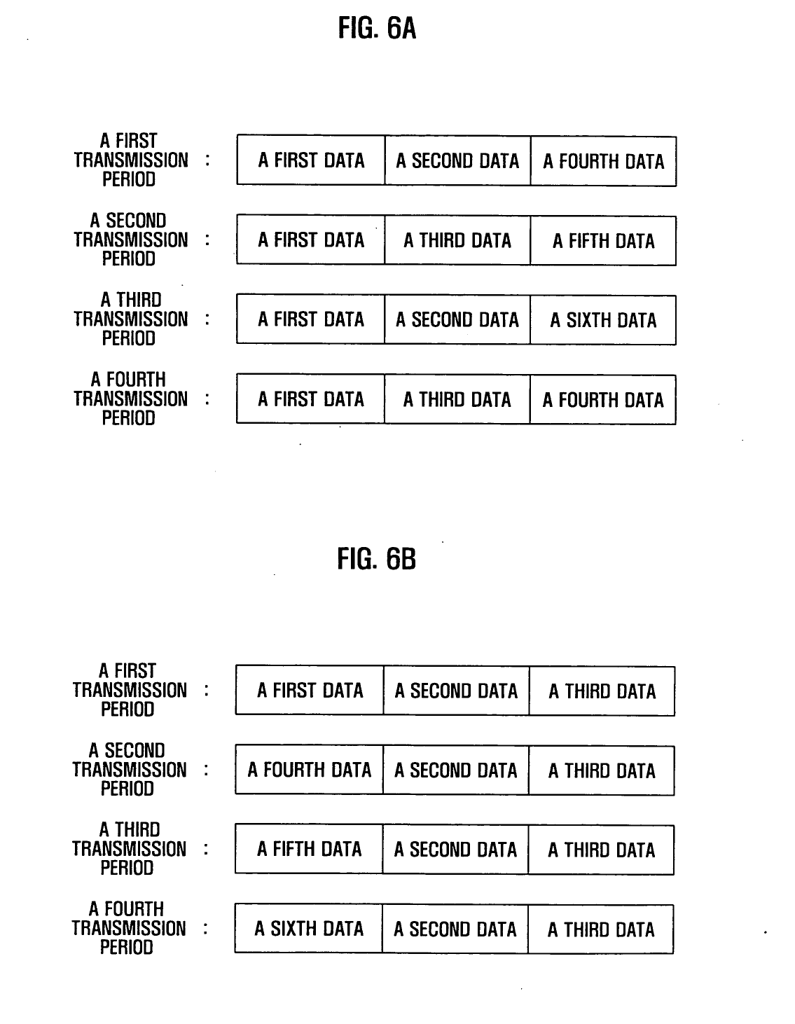

FIG. 6A, FIG. 6B are drawings showing a constitutional example of broadcast data generated by using the transmission period information exemplified in FIG. 4.

FIG. 6A shows an example of broadcast data generated by using transmission period information exemplified in FIG. 4 in time slot 08:00˜08:59. FIG. 6B shows an examples of broadcast data generated by using transmission period information exemplified in FIG. 4 in time slot 09:00˜09:59.

Referring to FIG. 6A, in time slot 08:00˜08:59, the broadcast data generated in a first transmission period includes a first, a second and a fourth data, while broadcast data generated in a second transmission period includes the first, a third, and a fifth data. Further, broadcast data generated in a third transmission period includes the first, the second and a sixth data, while broadcast data generated in a fourth transmission period includes the first, the third and the fourth data.

The first data is included in the broadcast data of all transmission periods, while the second and the third data are included in the broadcast data which are generated in every two transmission periods, and the fourth, the fifth and the sixth data are included in the broadcast data which are generated in every three transmission periods.

As to the first data, the transmission period is identical with T, which is the basic transmission period, while the transmission period of the second and the third data is identical with 2T, which is two times of the basic transmission period, and the transmission period of the fourth, fifth and sixth data is identical with 3T, which is three times of the basic transmission period

Referring to FIG. 6A, in time slot 09:00˜09:59, the broadcast data generated in a first transmission period includes a first, a second and a third data, while broadcast data generated in a second transmission period includes a fourth data, the second and the third data. Further, broadcast data generated in a third transmission period includes a fifth data, the second and the third data, while broadcast data generated in a fourth transmission period includes a sixth data, the second and the third data.

The first, the fourth, the fifth and the sixth data are included in the broadcast data in every four transmission periods, while the second and the third data are included in the broadcast data of all transmission periods. The reason is that the transmission period of the first, the fourth, the fifth and the sixth data is 4 T, which is four times the basic transmission period, while the transmission period of the second and the third data is identical with T, which is the basic transmission period.

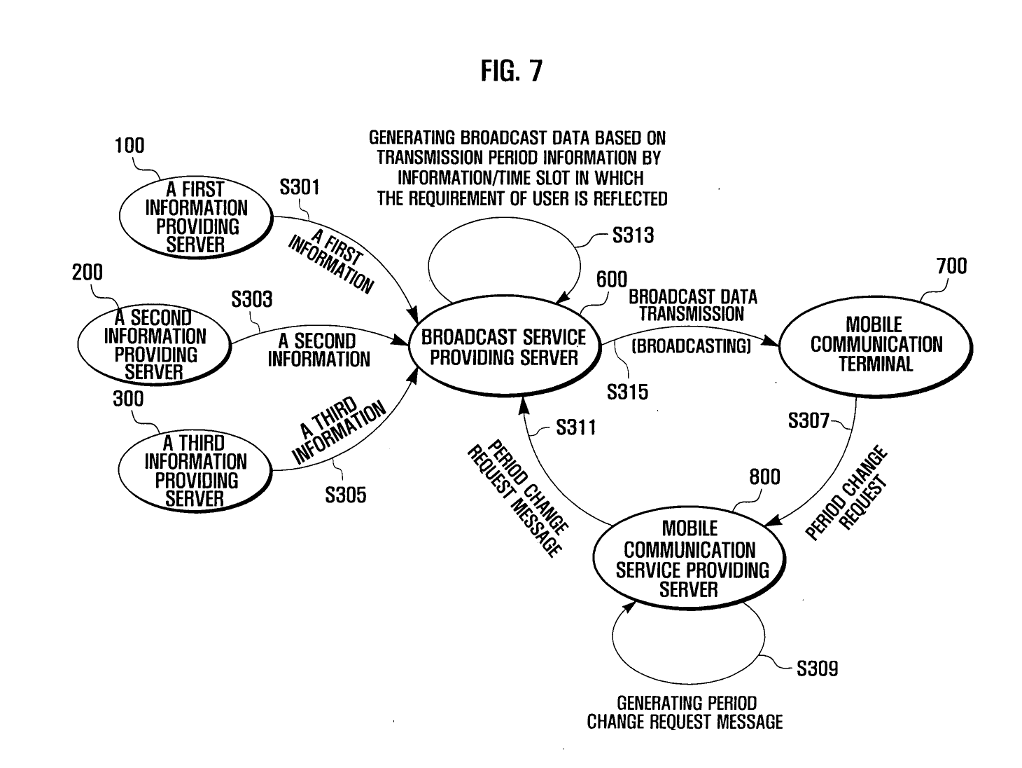

FIG. 7 is a drawing showing an example of the process of transmission of broadcast data including a plurality of information according to a second embodiment: of the present invention.

FIG. 7 shows the example of the process where the transmission period of each information differently set up by the kind of the information and according to the requirement of a user is stored in the broadcast service- providing server providing broadcast service, while the broadcast service providing server generates and transmits the broadcast data including the information based on the transmission period.

It is preferable that the user transmits the broadcast data period change request message to the broadcast service providing server through the mobile radio communications network. The broadcast service providing server sets up the transmission period by information/time slot in which the requirement of the user is reflected by using the statistical information for the requirement of user of the unspecified individuals.

Referring to FIG. 7, the broadcast service providing server 600 receives a first information from a first information providing server 100 S301, receives a second information from a second information providing server 200 S303, and receives a third information from a third information providing server 300 S305, to store/manage the information.

A user requests the period change of a specific information which is included in the broadcast data to the mobile communication service providing server 800 through the mobile communication terminal 700 S307.

For example, through the mobile communication terminal 700, the user requests that the transmission period of the data that is desired to be more frequently broadcasted should be shortened. It is preferable that the user requests data in the desired time slot when the corresponding data is more frequently put on the air.

It is also preferable that the mobile communication terminal 700 transmits the kind of the selected information such as traffic information, weather information and stock information with identifying information such as the telephone number based on the selection information of the user. That is to exclude the repetitive information request by the same user in case the mobile communication service providing server 800 counts the number of the change request.

The mobile communication service providing server 800 receives the period change request from the mobile communication terminal 700, generates the period change request message based on the request-information S309, and transmits the message to the broadcast service providing server 600 S311.

It is preferable that the mobile communication service providing server 800 generates the period change request message based on the information after collecting the period change request-information transmitted through the mobile communication terminals 700 of the unspecified individuals. Particularly, it is preferable that the mobile communication service providing server 800 generates the period change request message by collecting the change request-information by specific time unit, or generating the period change request message by collecting the received change request-information when the change request number is a specific number or greater, while the number is set up in advance.

For this, it is preferable that the mobile communication service providing server 800 counts the number of the period change request received from the mobile communication terminal 700, generates the period change request message including the transmission period by information/time slot which is set up by using a statistical information after generating the statistical information of the period change request-information transmitted from the unspecified individuals users based on the information collecting condition.

The mobile communication service providing server 800 does not increase a count for the change request-information which is repetitively delivered through the same mobile communication terminal 700 in a predetermined unit time in case the period change request is counted. This is to exclude a repetitive information request by the same user.

It is preferable that the mobile communication service providing server 800 receives the period change request-information including an user identification information such as telephone number and information identifying information which is a period change request object from the mobile communication terminal 700, and distinguishing the user transmitted the period change request-information based on the user identification information.

Further, in case the change request message includes only the statistical information, it is preferable that the mobile communication service providing server 800 counts the number of the change request delivered through the mobile communication terminal 700 by information and by time, and generates the period change request message including only the statistical information of the number of change request by information/time slot.

The change request message is transmitted to the broadcast service providing server 600 in S311. The broadcast service providing server 600 stores the transmission period information by information/time slot after setting up the transmission period information by information/time slot based on the statistical information.

In the meantime, in case the period change request message includes the transmission period by information/time slot, it is preferable that the mobile communication service providing server 800 sets up the transmission period by information/time slot based on the change request number after counting the change request number delivered through the mobile communication terminal 700 by information/time slot. The period change request message that includes the transmission period by information/time slot is generated to be transmitted to the broadcast service providing server 600.

It is preferable that, as to transmission period by information/time slot generated in either the broadcast service providing server 600 or the mobile communication service providing server 800, that the transmission period of the information having the more number of change request is shortend.

In this way, the broadcast service providing server 600 that stores the transmission period information by information/time slot in which the requirement of user is reflected generates broadcast data including at least one of the first information, the second information and the third information based on the transmission period information by information/time slot S313. It is preferable that the first to the third information are all kinds of live information such as traffic information, weather information and stock information.

In this way, the broadcast service providing server 600 that generates broadcast data based on the transmission period information by information/time slot, in which the requirement of user is reflected broadcasts the broadcast data to the mobile communication terminal 700 S315. It is preferable that the broadcast service providing server 600 transmits the generated broadcast data based on the broadcast data transmission period set up in advance to the mobile communication terminal 700.

As described in the above, broadcast data is generated and transmitted based on the transmission period information by information/time slot in which the requirement of user is reflected. Therefore, it is preferable that the broadcast service providing server 600 sets up the transmission period information by information/time slot in consideration of the requirement of user and the characteristic of each bit of information.

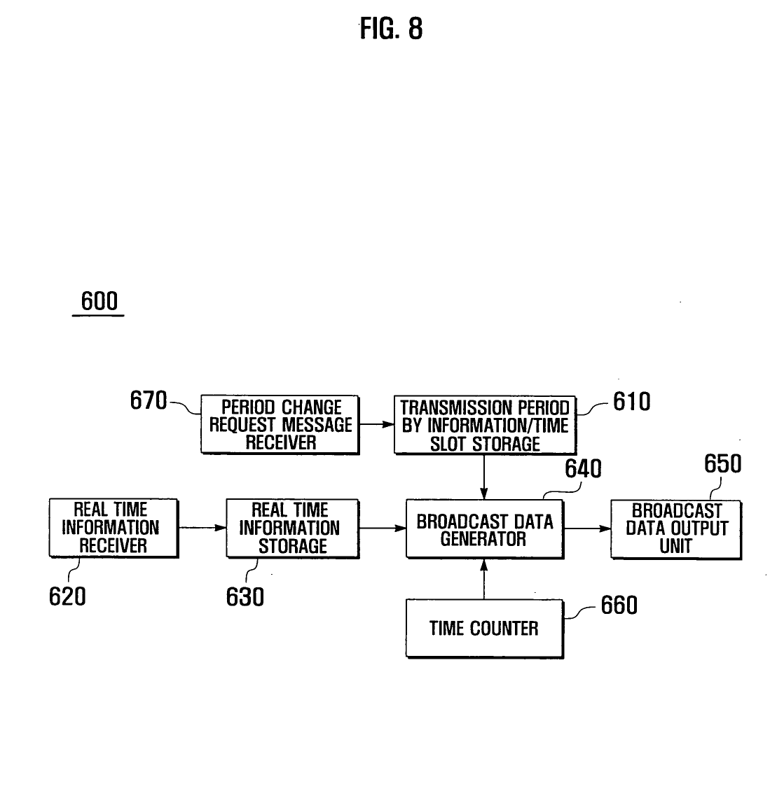

FIG. 8 is a block diagram showing a broadcast service providing server for performing the process exemplified in FIG. 7. That is, FIG. 8 is a block of the broadcast service providing server 600 exemplified in FIG. 7.

Referring to FIG. 8, the broadcast service providing server 600 includes a transmission period by information/time slot storage 610, a real time information receiver 620, a real time information storage 630, a broadcasting data generator 640, a broadcast data output unit 650, a time counter 660 and a period change request message receiver 670.

The transmission period by information/time storage 610 stores the transmission period information set up in advance for all the information that can be transmitted with broadcast data. It is preferable that the transmission period information is differently set up according to the demand of the users. For this, it is preferable that the broadcast service providing server 600 receives the period change request message delivered from the mobile communication service providing server 800 in FIG. 7 and stores the transmission period information based on the period change request message.

In that case where the received period change request message includes the transmission period by information/time, the transmission period by information/time storage 610 stores the transmission period as it is.

And it is preferable that, in the case where the received period change request message includes only the statistical information on the requirement of user of the unspecified individuals, the transmission period by information/time storage 610 stores the transmission period by information/time by using the statistical information after setting up the transmission period by information/time. The example of the stored transmission period information storing is identical with FIG. 4.

The real time information receiver 620 receives information transmitted from the outside information providing server in real time. Particularly, the real time information receiver 620 receives corresponding information from various information providing servers providing live information including traffic information, weather information, and stock information. The received information is delivered to the real time information storage 630.

The real time information storage 630 receives and stores real time information delivered from the real time information receiver 620. The real time information storage 630 stores information with the identifying information.

The broadcasting data generator 640 generates broadcast data based on the broadcast data transmission period set up in advance. Particularly, the broadcasting data generator 640 generates broadcast data including information stored in the real time information storage 630 based on the transmission period information stored in the transmission period by information/time storage 610.

It is preferable that the broadcasting data generator 640 generates broadcast data based on the transmission period information by information/time in which the requirement of user is reflected. For this, the broadcasting data generator 640 receives broadcast data transmission period information from the time counter 660 and generates broadcast data at the broadcast data transmission.

The time counter 660 counts the time to deliver for the broadcasting data generator 640. Particularly, the time counter 660 stores the transmission period information of broadcast data and counts the time so as to deliver it to the broadcasting data generator 640 at the proper transmission period.

The broadcast data output unit 650 receives broadcast data generated in the broadcasting data generator 640 in the proper broadcast data transmission period to output the broadcast data. That is, the broadcast data is broadcasted.

FIGS. 9A to 9B and FIGS. 10A to 10B are drawings showing an example of the process among a mobile communication terminal, a mobile communication service providing server and a broadcast service providing server for performing the process exemplified in FIG. 7.

FIGS. 9A to 9B and FIGS. 10A to 10B are examples of transmitting broadcast data based on the transmission period information by information/time in which the requirement of user is reflected.

Particularly, FIGS. 9A to 9b show the example of the process where the mobile communication service providing server 800 performs the establishment of the transmission period by information/time among the process. FIGS. 10A to 10B show the example of the process where the broadcast service providing server 600 performs the establishment of the transmission period by information/time among the process.

Referring to FIGS. 9A to 9B, the broadcast data transmission process is shown in the case where the mobile communication service providing server 800 performs the establishment of the transmission period by information/time.

Firstly, if a user requests period change of a specific information, included in broadcast data, provided through the mobile communication terminal 700 S401, the mobile communication service providing server 800 receiving the request confirms the validity of a request-information S403. That is, it is confirmed whether the request-information is valid or not. In other words, it is preferable that the mobile communication service providing server 800 determines whether the received request-information is repetitively requested by the same user or not.

This is to exclude repetitive information requests by the same user in counting the number of change request in the mobile communication service providing server 800.

For this, it is preferable that the mobile communication terminal 700 transmits period change request-information including the kind of information selected based on the selection information of user such as traffic information, weather information and stock information and identifying information such as telephone number.

Further, it is preferable that the mobile communication service providing server 800 manages/stores the period change request-information by terminal or user based on the user identification information included in the period change request-information and confirm the validity of the received period change request based on the information.

If the request-information is valid as a result of the confirmation S403, that is, in case the request-information is not repetitively requested by the same user, the mobile communication service providing server 800 stores the received period change request-information in a request-information management by terminal table S405.

The request-information management by terminal table is the table for counting the number of period change request received in a specific duration, managing/storing the received period change request-information by terminal.

In the process S403, the request-information management by terminal table is the table to which the mobile communication service providing server 800 refers for confirming the validity of the period change request-information.

The example of data storage in the request-information management by terminal table is exemplified in FIG. 11A. Referring to FIG. 11A, the request-information management by terminal table 810 includes a terminal identification information ID, and the transmission period change request-information that the terminal requested for transmission period change.

The request-information management by terminal table 810 stores the necessary information to confirm whether the period change request-information that the mobile communication service providing server 800 received is repetitively delivered in the specific duration by the same user or not. For this, it is desirable that the request-information management by terminal table 810 is to be reset in the specific duration, that is, the request-information collection unit time, for example every half an hour.

Therefore, the mobile communication service providing server 800 repeatedly executes the process S401 to S405 with counting time as described in FIGS. 9A to 9B until the request-information collection unit time.

If it is request-information collection unit time S407, after renewing the request-information management by time slot table based on the request-information management by terminal table 810 exemplified in the FIG. 11A S409, the mobile communication service providing server 800 resets the request-information management by terminal table S411.

The request-information management by time slot table is a table for managing the statistical information on the requirement of userof the unspecified individuals. The data storage example of the request-information management by time slot table is exemplified in FIG. 11B.

Referring to FIG. 11B, the request-information management by time slot table 820 stores the number of change request classified by each information by time.

That is, as shown in FIG. 11B, in time slot 08:00˜08:59, a first data is requested 10 times, 8 times for second data, 1 time for third data and 8 times for n-th data. In time slot 09:00˜09:59, a first data is requested 6 times, 10 times for a second data, 3 times for a third data and 4 times for n-th data.

Particularly, FIG. 11B illustrating an example of storing/managing the number of period change request of the informations by time in case the request-information collection unit time is 1 hour.

Referring again to FIGS. 9A to 9B, in the process S409, after renewing the request-information management by time slot table as exemplified in FIG. 11B based on the request-information management by terminal table 810 as exemplified in the FIG. 11A, the mobile communication service providing server 800 which reset the request-information management by terminal table in the process S411 confirms whether the present operation state satisfies the period setting information update condition set up in advance for the transmission period information by information/time stored in the broadcast service providing server 600 in advance or not S413.

For example, it is confirmed whether the current time satisfies the time period set up in advance for the period setting information update as a result of time count or not.

The mobile communication service providing server 800 repeatedly executes a series of the process S401 to S413 until the condition is satisfied. In the case where the condition is satisfied, the mobile communication service providing server 800 sets up the transmission period by information/time slot in which the requirement of user is reflected based on the request-information management by time slot table S415.

It is preferable that the mobile communication service providing server 800 refers to the period setting table 830 as exemplified in the FIG. 11C for the setting of the transmission period. The period setting table 830 stores period setting information on the period change request number with reference to the FIG. 11C.

As shown in FIG. 11C, when the basic period is T, the period setting information of data in which the period change request number is 5 times or less is 5T, while the period setting information of data in which the period change request number is 6 times˜10 times is 4T. The period setting information of data in which the period change request number is 11 times˜15 times is 3 T. The period setting information of data in which the period change request number is 16 times˜20 times is 2 T. The period setting information of data in which the period change request number is over 20 times is T. It is preferable that the period setting table 830 is stored in the mobile communication service providing server 800.

Therefore, in case of setting up the period of each data based on the statistical information stored in the request-information management by time slot table 820 in FIG. 11B and the period setting table 830 shown in FIG. 11C, the transmission period of a first, a second and n-th data is set up as 4 T, while the transmission period of a third data is set up as 5 T in time slot 08:00˜08:59.

As described in the above, the mobile communication service providing server 800 setting up the transmission period by information/time slot in which the requirement of user is reflected in the process S415 of FIGS. 9A TO 9B transmits the transmission period by information/time slot to the broadcast service providing server 600 S417. For this, it is preferable that the mobile communication service providing server 800 delivers the period change request message after generating the period change request message including the transmission period information.

The broadcast service providing server 600 receiving the transmission period information stores the transmission period by information/time slot S419, repeatedly executing the process S421 where real time information is received and stored until the basic transmission period for transmission of broadcast data.

When it is the basic transmission period S423, the broadcast service providing server 600 generates broadcast data based on the transmission period information by information/time slot stored in the process of S419 at S425, and transmits the broadcast data to the mobile communication terminal 700, that is, performs broadcasting S427. The broadcasting of the broadcast data is done in accordance with FIGS. 6A and 6B.

Referring to FIGS. 10A to 10B, the broadcast data transmission process according to the present invention is shown in case the mobile communication service providing server 800 performs the establishment of the transmission period by information/time.

Firstly, if a user requests period change of a specific information, included in broadcast data, provided through the mobile communication terminal 700 S501, the mobile communication service providing server 800 receiving the request confirms the validity of a request-information S503. That is, it is confirmed whether the request-information is valid or not. In other words, it is preferable that the mobile communication service providing server 800 determines whether the received request-information is repetitively requested by the same user or not. The detailed descriptions are the same as described above.

If the request-information is valid as a result of the confirmation S503, that is, in case the request-information is not repetitively requested by the same user, the mobile communication service providing server 800 stores the received period change request-information in a request-information management by terminal table S505.

The request-information management by terminal table is the table for counting the number of period change requests received in a specific duration, and managing/storing the received period change request-information by the terminal.

In the process S503, the request-information management by terminal table is the table to which the mobile communication service providing server 800 refers to for confirming the validity of the period change request-information.

It is desirable that the request-information management by terminal table is to be reset in the specific duration, or the request-information collection unit time, for example every half an hour.

The example of data storage in the request-information management by terminal table is exemplified in FIG. 11A.

The mobile communication service providing server 800 repeatedly executes the process S501 to S505 with counting time as described in FIGS. 9A to 9B until the request-information collection unit time.

If the request-information collection unit time comes S507, after renewing the request-information management by the time slot table based on the request-information management by the terminal table 810 exemplified in the FIG. 11A S509, the mobile communication service providing server 800 resets the request-information management by the terminal table S511. That is, the content of the request-information management by terminal table is deleted.

The request-information management by time slot table is a table for managing the statistical information based on the requirements of the user of the unspecified individuals. The data storage example of the request-information management by time slot table is exemplified in FIG. 11B.

The mobile communication service providing server 800 confirms whether the present operation state satisfies the period setting information update condition set up in advance for the transmission period information by information/time stored in the broadcast service providing server 600 in advance or not S513.

For example, it is confirmed whether the current time satisfies the time period set up in advance for the period setting information update as a result of time count or not.

The mobile communication service providing server 800 repeatedly executes a series of the process S501 to S513 until the condition is satisfied. In the case where the condition is satisfied, the mobile communication service providing server 800 transmits the request-information management by time slot table to the broadcast service providing server 600 S515.

It is preferable that the mobile communication service providing server 800 delivers the period change request message after generating the period change request message including the request-information management by the time slot table 820. As a result, it is possible that the transmission period by information/time slot is directly set up in the broadcast service providing server 600.

The broadcast service providing server 600 receiving the request-information management by the time slot table sets up the transmission period by information/time slot in which the requirement, of the user is reflected based on the request-information management by the time slot table S517.

It is preferable that the broadcast service providing server 600 refers to the period setting table 830 as exemplified in the FIG. 11C for the setting of the transmission period.

In FIGS. 10A to 10B, it is preferable that the period setting table 830 is stored in the broadcast service providing server 800.

The broadcast service providing server 600 stores the transmission period by information/time slot set in the process of S517 at S519, and repeatedly executes the process S521 where real time information is received and stored until the basic transmission period for transmission of broadcast data.

When the basic transmission period is acquired S523, the broadcast service providing server 600 generates broadcast data based on the transmission period information by information/time slot stored in the process of S519 at S525, and transmits the broadcast data to the mobile communication terminal 700, that is, performs broadcasting S527. The broadcasting of the broadcast data is done in accordance with FIG. 6A and FIG. 6B.

In FIGS. 9A to 9B and FIGS. 10A to 10B, it is illustrated that the mobile communication service providing server 800 generates the statistical information by collecting period change request-information received at the request-information collection unit time that is set before. However, the point in time of collecting the information is not restricted as a time unit.

For example, the mobile communication service providing server 800 is able to generate the statistical information by collecting the period change request-information when the number of the period change requests received is identical with the number of the request-information collection unit that is set before.

It is preferable that the mobile communication service providing server 800 generates the statistical information by sorting the information based on the number of the period change requests by information after the number of the period change requests of each period the change request of the object information which has been collected is determined when the number of the period change requests received is equal to the number of the request-information collection unit that is set before. Then, an up/down adjustment of the transmission period may be determined based on the sorting sequence.

For example, it is preferable that the transmission period of the information having many period change requests based on the sorting sequence is decreased, while the transmission period of the information in which the period change requests having a small period change request is increased.

Further, it is preferable that the mobile communication terminal 700 receiving broadcast data including a plurality of information by the processing exemplified in FIGS. 9A to 9B, FIGS. 10A to 10B includes a receiver that receives broadcast data from the broadcast service providing server 600, a transmitter that transmits the period change request-information for the information needs to be changed among the information included in broadcast data to the mobile communication service providing server 800, and a controller for controlling the overall operation of the receiver/transmitter and the mobile communication terminal 700.

Particularly, it is preferable that the controller generates the change request-information of the transmission period based on the specific information from among the informations based on the selection information of user, and transmits the information to the mobile communication service providing server 800 through the transmitter.

For this, the controller generates the change request-information that includes identifying information of the mobile communication terminal 700 and an identifying information of the information that is the object of the change request of the transmission period.

The present invention described above, as to the transmission method of broadcast data including a plurality of information and apparatus of the same, has the effect that users are capable of being provided with a convenient live information usage by the kind of information and by time slot by differentiating the transmission period of the information.

Further, the present invention has the effect that the information desired by users can be provided by reflecting the requirement of the user in a transmission period setting of the information. Furthermore, the present invention has the additional effect that the live information needed by users is provided for the users convenience to raise the broadcast data audience rating by activating the development of the digital contents for broadcasting. Although the present invention has been described with respect to traffic, weather and stock information, all other time sensitive types of information are contemplated.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for scheduling the transmission of broadcast data that includes a plurality of informations, the method comprising:
setting up a transmission period based on an information/time slot for each of the plurality of information;
receiving information transmitted from information providing servers;
storing the received information;
generating broadcast data that includes the stored information based on the transmission period of the information; and
broadcasting the generated broadcast data.

2. The method of claim 1, wherein the transmission period is based on the content of the information.

3. The method of claim 1, wherein the plurality of information and the transmission period by time slot are set up based on requirements of a user delivered by using the mobile communications network.

4. The method of claim 1, wherein the step of setting up the transmission period, further comprises:
receiving a period change request-information of user for a specific information by using the mobile communications network;
counting the number of the received period change requests;
generating the statistical information of the period change request-information from users based on a preset information collecting condition; and
setting up the transmission period by information/time slot by using the statistical information.

5. The method of claim 4, wherein the period change request-information includes identification information transmitting the period change request-information and information identifying the information of which the period change request applies.

6. The method of claim 5, wherein the user transmitting the period change request-information is determined based on the identification information of the user included in the period change request-information, and the number of the period change request is not increased for a period change request repetitively transmitted by the same user in a predetermined unit of time.

7. The method of claim 4, the number of the period change requests of each information by each request-information collection unit time is generated.

8. The method of claim 7, wherein the statistical information generating step comprises:
setting period setting information for the number of period change request; and
setting up the transmission period of each information based on the number of the period change request of each information included in the statistical information and the period setting information.

9. The method of claim 4, wherein the statistical information sorting the information based on the number of period change request by information is generated after the number of period change request of each period change request object informations which has been collected is determined, when the number of period change request receiving is equal to the number of the preset request-information collection unit.

10. The method of claim 9, wherein an adjustment of the transmission period is determined based on the sorting sequence of the information.

11. The method of claim 4, wherein the transmission period setup step is performed in a broadcast service providing server based on statistical information generated in a mobile communication service providing server.

12. The method of claim 4, wherein the transmission period setup step is performed in a mobile communication service providing server generating statistical information.

13. The method of claim 4, wherein the transmission period by information/time slot is set up based on a multiple of the transmission period of the broadcast data.

14. An apparatus for scheduling the transmission of broadcast data, the apparatus comprising:
a transmission period storage for storing a preset transmission period of an information/time slot for a plurality of information that can be transmitted in broadcast data;
an information receiver for receiving information transmitted from an outside information providing server;
an information storage for storing the received information;
a broadcasting data generator for generating broadcast data that includes the information stored in the information storage based on the transmission period information stored in the transmission period; and
a broadcast data output unit for broadcasting the broadcast data.

15. The apparatus of claim 14, wherein the transmission period storage predicts the demand of the information based on the content of the information, and stores the transmission period of an information/time slot set up based on a sequence of the information.

16. The apparatus of claim 14, further comprising a period change request message receiver for receiving a transmission period change require-message that contains information scheduling requirement of a user delivered through a mobile radio communications network is reflected,
wherein the transmission period storage stores the transmission period of an information/time slot in which the requirement of user is reflected based on the period change request message.

17. The apparatus of claim 16, wherein the transmission period storage stores the transmission period of an information/time slot in the case of receiving the period change request message including the transmission period of an information/time slot.

18. The apparatus of claim 16, wherein the transmission period storage stores the transmission period of an information/time slot after setting up the transmission period of an information/time slot by using the statistical information in the case of including the statistical information on the requirement of users.

19. A mobile communication terminal capable of receiving broadcast data, comprising:
a receiver for receiving broadcast data that includes a plurality of information;
a controller generating change request-information of a transmission period of specific information among the information based on selection information of a user; and
a transmitter for transmitting the change request-information.

20. The mobile communication terminal of claim 19, wherein the controller generates a change request-information that includes identifying information of the mobile communication terminal and identifying information of the information that is an object of the transmission period change request.
